(19) United States
(12) Patent Application Publication
(10) Pub. No.: US 2012/0028508 A1
(43) Pub. Date: Feb. 2, 2012

(54) Memory Jack

(76) Inventor: Brandal Johnston, Horn Lake, MS (US)

(21) Appl. No.: 13/101,120

(22) Filed: May 4, 2011

Related U.S. Application Data
(60) Provisional application No. 61/343,776, filed on May 4, 2010.

(51) Int. Cl. H01R 24/00

(52) U.S. Cl. 439/668

(57) ABSTRACT

An inconspicuous data storage device disguised as a communications jack secured to a wall or other relatively immobile object and linked to a computer with a breakaway data transfer cable.

This application claims the benefit of provisional U.S. Patent application Ser. No. 61/343,776 filed on May 4, 2010 entitled Minute Mat, Memory Jack, Stick It Memory Gate Adjustable Eye Ball, Offset Adjustable Eyeball herein incorporated by reference.

### BACKGROUND OF THE INVENTION

This invention relates generally to computer data storage backup systems. More particularly, it relates to data storage devices that are hidden away from view.

Theft of a computer results in a loss of the computer hardware, and a loss of the data stored on the stolen computer. Storing a copy of one's files on a backup drive storage device can minimize the loss of data. Backup files are difficult to remember to create, however and if the backup files are stored on a drive near, within or attached to the computer, they may be stolen along with the computer itself. Storing the files in a remote location, while preferred, requires the user to leave the computer workstation to retrieve or deposit the data backups. Should the user forget the secure location, or misplace the hardware; the backup files may be lost. Network computing allows for backup files to exist on another computer, or possibly on a file server in a different location, however, such systems can be expensive to maintain, require a network connection and can be susceptible to network security threats.

A need exists for an inexpensive, robust, simple to use backup system that may be left continuously attached to the computer for ease of use, but likely to be left behind should the computer be stolen.

### BRIEF SUMMARY OF THE INVENTION

The invention allows the user to store data safely and securely by connecting the computer directly to a memory storage drive that is safely hidden from view. In the preferred embodiment, the device is disguised as a wall communications jack plate, such as a phone or networking jack. In this preferred embodiment, the data is stored securely behind the wall plate on a non-volatile memory storage device such as a flash memory card that may be securely or removably attached to the wall plate housing. A connecting cable allows transfer of the digital information between the computer and the memory storage drive contained within the housing. In a second embodiment, the invention is configured to resemble a surface mounted phone jack for mounting under or behind a desk, having the memory storage device mounted within the housing.

### BRIEF DESCRIPTION OF THE DRAWINGS

The invention is illustrated by the accompanying drawings, in which:

FIG. 1 is a front perspective view of a first embodiment of the invention showing a jack plate having memory card storage slots with a communications style jack placed center of the housing.

FIG. 2 is a lower front perspective view of the invention also showing a breakaway cable connector.

FIG. 3 is a front perspective view of a second version of the first embodiment of the invention with the telephone style jack placed in the upper front surface of the housing.

FIG. 4 is a cutaway front perspective view of the first embodiment of the invention showing the processing circuit and memory card slots.

FIG. 5 is a front perspective view of a second embodiment of the invention having a surface mount style telephone jack housing showing the data cable connector jack and memory card connector slots.

### DETAILED DESCRIPTION OF THE INVENTION

The drawings illustrate an invention that enables an individual to easily store data in a discrete location. The data drive can be used as an external drive to store original files in a secure location, or may be used as a redundant backup. The invention is configured to resemble a communications port, such as a telephone or Ethernet jack secured to a wall or other object. In the event the computer is moved, the cord will disconnect and the invention will remain behind. The inconspicuous configuration of the invention will increase the likelihood that a thief will leave it untouched.

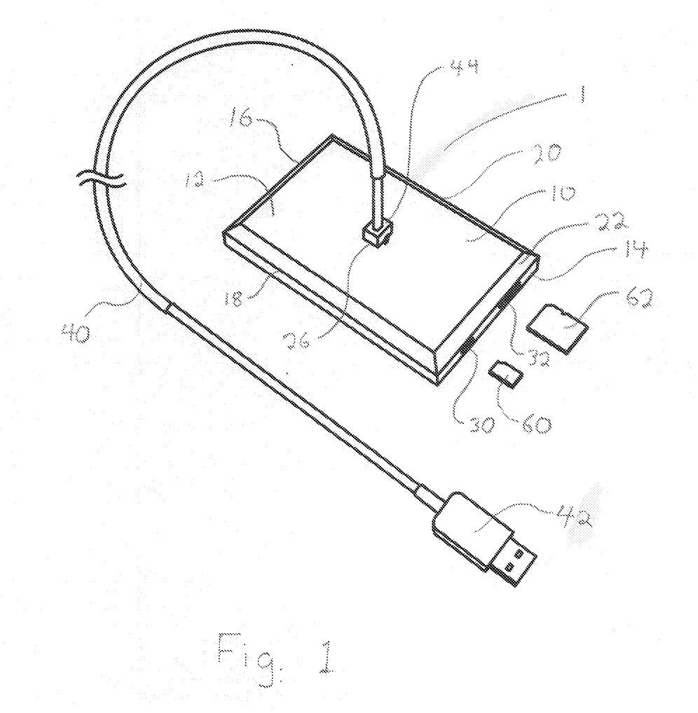

FIG. 1 is a perspective view of a first embodiment of the present invention 1 having a housing 10, a data cable 40 and at least one memory storage drive 60 or 62. The housing 10 is rectangular in shape, having a front face 12, a lower edge face 14, an upper edge face 16, a left edge face 18 and a right edge face 20. While the front face 12 in this embodiment possesses chamfered edges 22, the edges may alternatively be square, or rounded. A communications style jack 26, such as a telephone 6P6C or Ethernet 8P8C style jack, is positioned in the center of the housing 10 front face 12.

In this first embodiment, the cable 40 possesses a USB compatible male connector plug 42 and a communication style plug 44. The cable 40 may securely connect each plug 42, 44, or may be designed to disconnect or break should it experience sufficient strain.

In this first embodiment 10, the housing contains slots 30 and 32 for receipt of memory card storage media 60 or 62. The invention 10, may contain a single slot 30 or 32 for receipt of a single memory card 60 or 62, or may contain a plurality of slots 30 and 32 for receipt of one or more memory cards 60 and 62. Each slot 30 or 32 may be configured to receive multiple styles of memory cards 60 or 62.

In this first embodiment, the memory cards 60 or 62 may be removed, replaced or upgraded at any time. The slots 30 and 32 are discretely positioned in one of the edge faces 14, 16, 18 or 20 and may not be noticed to a casual observer. To use this embodiment of the invention 1, a user inserts a flash memory card 60 or 62, into a slot 30 or 32. The data transmission cable 40 is connected to port 26 of the housing 10 and to the user's computer via USB connector 42. The housing 10 may be mounted to a relatively immovable object such as a wall, desk, or floor. The housing may be secured using double sided tape. The user can then use the invention as a backup storage drive or as a primary drive by moving, copying, creating, editing or otherwise accessing data files on the data storage disks 60 and/or 62 through the computer interface. The device may be left connected to the computer because the breakaway cable or breakaway cable connector will prevent the invention from being torn from its mounted position. In the event that a person of less than stellar morals appropriates the computer, the data storage device will likely be left behind because of the inconspicuous shape and breakaway cable 40 or releasably attached connectors 42 or 44.

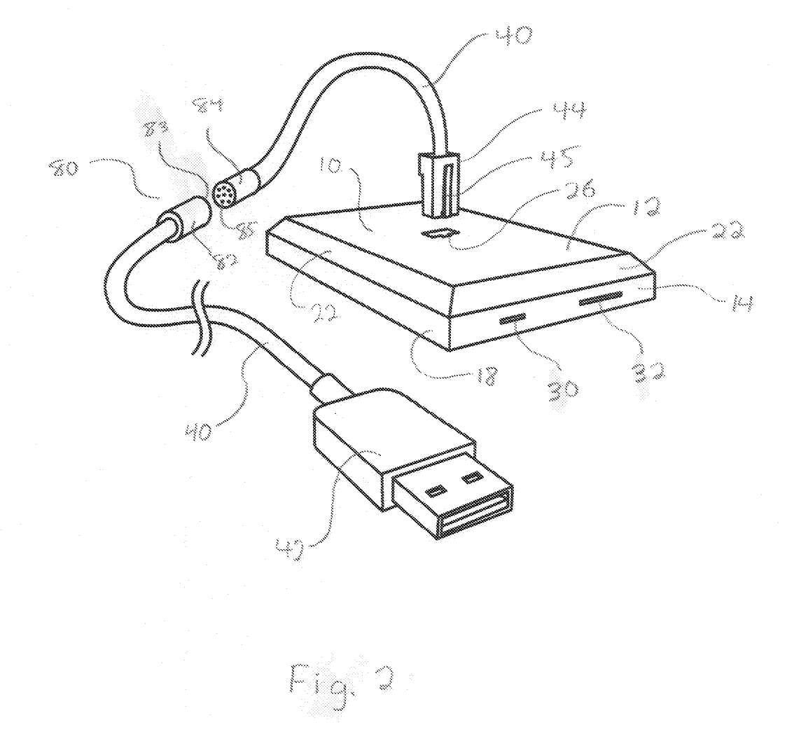

FIG. 2 is a perspective view of the invention showing the data flash drives 60, 62 inserted into slots 30, 32 and the connector 44 aligned with, but not inserted into the communications style jack 26. The connector 44 possesses a tab 45 to emulate the locking tab often found on similarly styled connectors. Here the connector 44 does not possess a locking barb on the tab 45, thus the connector may disconnect from the jack 26 upon applying a predetermined tension to the cord. Here the cable 40 contains a break-away connector 80 that disconnects under a predetermined tension. The break-away connector 80, may be comprised of two portions, 82 and 84 and may possess a female connector array 85 and a male connector array 83.

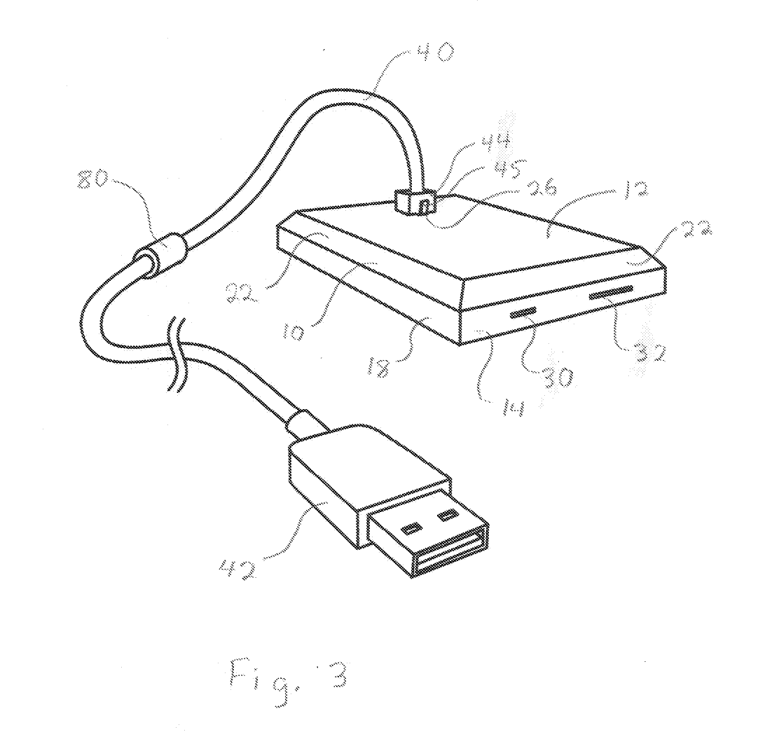

FIG. 3 is a perspective view an alternative version of the first embodiment, having the jack 26 placed closer to the upper portion of the face 12 of the housing 10. The cable 40 contains a break-away connector 80. USB connector 42 is shown replaced with another style of connector, an 8P8C connector 46 for insertion into the computer's Ethernet jack.

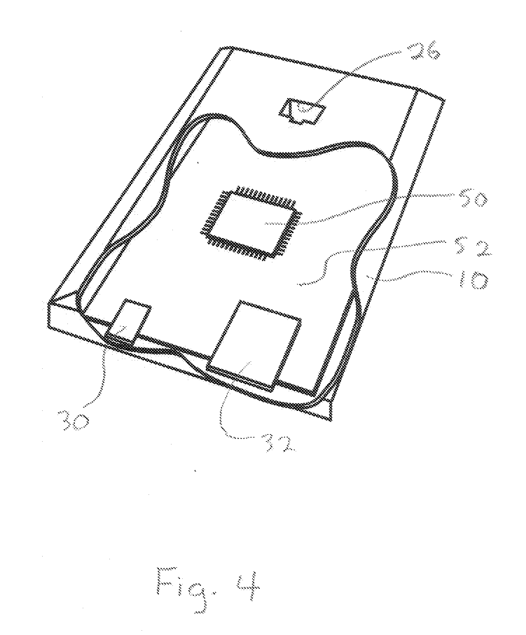

FIG. 4 is a cutaway view showing the flash memory controller circuitry 50, a circuit board 52, flash memory card connectors 30 or 32, and data transfer connection jack 26 housed within the housing 10. The memory controller circuitry 50 may also have the ability to store data and/or process data for encryption, password protection, or pass code storage. The built in circuitry 50 of the invention 1 may contain a sufficient amount of memory for backup data storage. In the event that sufficient memory is built in to the circuitry 50, the invention 1 may not possess flash memory card connectors 30 or 32, or may possess one or more flash memory card connectors 30 or 32. to allow for additional data storage.

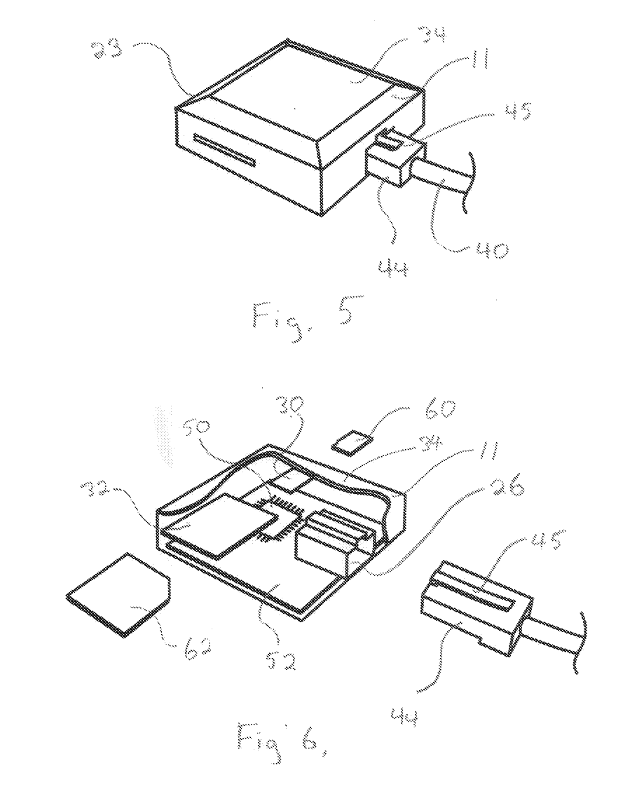

FIG. 5 shows an alternative embodiment of the invention 1 that is configured to look like a surface mount phone jack receptacle housing 11. The data transfer connection 26 is located on an edge surface. The flash memory card connectors 30 or 32 are also located on an edge surface.

FIG. 6 shows a cutaway view of the alternative embodiment resembling a surface mount phone jack receptacle housing 11. The circuit board 52, data cable jack connector 26, memory controller microchip 50 and flash memory card slots 30 and 32 can be seen in the cutaway.

To increase heat and fire resistance, the housing 10 or 11 may be manufactured from a fire resistant or fire proof material.

The invention 1 may be attached to an immovable object, such as a wall, desk or floor. Preferably the device will be secured by double sided adhesive tape. Other means of securing the device may also be used to secure the invention 1, including screws or an adhesive.

What is claimed is:

1. An inconspicuous data storage device comprising:
A housing resembling a communications port;
A circuit board containing memory controller circuitry; and
A data transfer cable connecting said memory storage device to a computer.

2. The device of claim 1 wherein said housing possesses adhesive for securing said housing to a relatively immovable object.

3. The device of claim 1 wherein said housing is attached to a relatively immovable object with screws.

4. The device of claim 1 wherein said data transfer cable is releasably attached to said housing.

5. The device of claim 1 wherein said housing is constructed from fire resistant material.

6. The device of claim 1 wherein said data storage device is additionally comprised of at least one memory storage device connector.

7. The device of claim 1 wherein said data transfer cable possesses a breakaway connector.

8. The device of claim 1 wherein said data transfer cable possesses a USB connector plug for interfacing with said computer.

9. An inconspicuous data storage device comprising:
A housing resembling a communications wall jack port;
A circuit board secured to said housing containing memory controller circuitry;
At least one memory storage device connector connected to said circuit board;
A data transfer cable connector connected to said circuit board;
A data transfer cable connecting said memory storage device to a computer.

10. The device of claim 9 wherein said housing possesses adhesive for securing said housing to a relatively immovable object.

11. The device of claim 9 wherein said housing is attached to a relatively immovable object with screws.

12. The device of claim 9 wherein said data transfer cable is releasably attached to said housing.

13. The device of claim 9 wherein said housing is constructed from fire resistant material.

14. The device of claim 9 wherein said data transfer cable possesses a breakaway connector.

15. The device of claim 9 wherein said data transfer cable possesses a USB connector plug for interfacing with said computer.

15. An inconspicuous data storage device shaped to resemble a communications wall jack comprised of:
A housing possessing a rectangular front surface, an upper edge surface, a lower edge surface, a right edge surface and a left edge surface;
A circuit board secured within said housing, said circuit board containing memory controller circuitry;
At least one memory storage card connector connected to said circuit board, said memory storage device connector passing through said edge surface of said housing to allow egress and ingress of a memory storage card;
A data transfer cable connector jack connected to said circuit board, said data transfer cable connector jack passing through a surface of said housing to allow egress and ingress of a data transfer cable connector plug;
A data transfer cable connecting said memory storage device to a computer.
